(19) United States
(12) Patent Application Publication
(10) Pub. No.: US 2016/0227057 A1
(43) Pub. Date: Aug. 4, 2016

(54) Methods for Optimizing Display Space of a User Interface of an Imaging Apparatus

(71) Applicant: Lexmark International, Inc., Lexington, KY (US)

(72) Inventors: Daniel Blake Jarvis, Richmond, KY (US); Amanda Michelle Kosater, Loveland, OH (US); Alekhya Paruchuri, Hyderabad (IN); Warner Lee Wells, II, Versailles, KY (US); Jonathan Ashley Ward, Lexington, KY (US)

(21) Appl. No.: 14/611,410

(22) Filed: Feb. 2, 2015

(51) Int. Cl. H04N 1/00

(52) U.S. Cl. CPC H04N 1/00514; H04N 1/00474; H04N 1/00482; H04N 1/00413; H04N 1/00517; H04N 2201/0094

(57) ABSTRACT

An imaging apparatus including a user interface generating displays for optimizing a user's experience when indicating preferred options prior to performing a function. Displays for relatively large user interfaces are bifurcated into a settings pane including a plurality of settings associated with the selected function and a preset pane including a preconfigured set of settings and options for the same function. A transparent drawer—including specific settings and/or options corresponding to a setting from the settings pane—is operative to be launched and closed when the said setting has been selected and deselected, respectively. Selected options are implicitly stored and automatically summarized on the settings pane. Displays for relatively small user interfaces also feature a bifurcated display manifested by a resizable settings pane operative to expand and reduce in response to user input, the resizable settings pane featuring a summary of selected options.

### FIELD OF THE INVENTION

The present invention relates to improving a user's experience when interfacing with an imaging apparatus and more particularly to optimizing display space of said user interfaces for users to efficiently indicate preferred options for the imaging apparatus to use in executing a function thereon.

### BACKGROUND

Prior to an imaging device executing a user-selected function, the user must indicate a set of preferences or preferred options in executing the function. For example, when a user indicates a desire to execute a copying function on a multifunction product (MFP), the MFP generates on its user interface settings corresponding to the copy function (e.g., “Content”, “Paper Details”, “Scale”, “Darkness”, “Custom Job”, or “Finishing Options” option, etc.) with each setting having a preconfigured set of options to choose from (e.g., “Photo”, “Text”, “Graphics”, “Text/Photo” options for the “Content” setting, etc.). Since an apparatus may be capable of performing multiple functions and each function may include a number of settings with associated options, existing user interfaces employ a separate display on the user interface for each setting. Upon function selection, for example, users are forced to navigate through a first display (e.g., “Scale” setting display) to select a preferred option for one particular setting (e.g., 50%) and out of the same display and into another when another setting is selected. More generally, users are required to navigate in and out of displays for indicating preferring options for settings. Buttons on a key panel, such as, “Back”, “Next”, “Home” or like buttons for manipulation on a key panel are often utilized to aid movement between displays. In this context, navigating between various displays in current user interfaces for an imaging apparatus commonly results in the user getting lost. While trail markers may be provided on the user interface for indicating a location of the user relative to a primary display or “home screen” (i.e., text above display citing “Home>Copy>First Setting> . . . >Paper Size> . . . ”), navigation is still tedious.

Typically, a detailed summary of selected options are provided only when desired options for all corresponding settings of the function have been selected or immediately prior to executing the function. As such, in order for users to check or change options from other settings or displays, users are required to go to each setting's respective display again, which is time-consuming. Thus, typical user interfaces for an imaging apparatus are not only tedious to navigate through but also fail to provide users an actual summary or preview thereon of previously selected options while selection is ongoing.

Accordingly, there is a need for generating displays on user interfaces of imaging apparatus that are easier and simpler to navigate. The need extends to better arrangement of display elements that correspond to the settings and options associated with the functions to be performed. Additional benefits and alternatives are also sought when devising solutions.

### SUMMARY

The above-mentioned and other problems are solved by systems and methods involving generation of displays for user interfaces of imaging apparatus having limited display space. In a representative embodiment, relatively large user interfaces have bifurcated displays including a first pane for the plurality of settings associated with the selected function to be performed and a second pane for a preconfigured set of settings and options (i.e., most commonly used) for the same function. A transparent drawer is operative to be launched or closed adjacent to the first pane and operative to hover over the second pane such that content on the second pane can be seen through the transparent surface of the drawer, simultaneously viewing information associated with the function selected to be performed. The first pane further provides a real-time summary of the selected options alongside respective settings while preferred or specific options for each setting thereon are selectable on a corresponding adjacent drawer.

Alternative displays directed to relatively small user interfaces meanwhile include a first landing screen display for primarily showing the preconfigured set of settings and options associated with the selected function to be performed. The first landing screen display for preset settings and options leads to a second landing screen display still including a bifurcated display manifested by a resizable settings pane giving way to an adjacent display area for generating specific options when one of the settings on the resizable settings pane has been selected. An execute button for activating execution of the selected function is included at any portion of the displays for accessing by users.

Other embodiments note techniques for including a notification bar at a topmost portion of the user interfaces so users can be notified of any events on the imaging apparatus which may be related to the function being performed or not; a control bar at a top portion of any generated display for identifying the selected function to be performed and enabling access to one or more shortcut buttons specific to the selected function (e.g., execute button); and alternative GUI elements to be utilized by users in specifying preferred options for a particular setting associated with the function to be performed, such as drop-down combo boxes, toggle boxes, etc. Software, executable code, interfaces, and computing system environments typify the embodiments.

These and other embodiments set forth in the description below. Their advantages and features will become readily apparent to skilled artisans. The claims set forth particular limitations.

### BRIEF DESCRIPTION OF THE DRAWINGS

FIG. 1 shows an imaging apparatus including a home screen for selecting a function;

FIG. 2 is a flowchart showing an example method for users to navigate on relatively large user interfaces according to FIGS. 3A-3E;

FIGS. 3A-3E show example displays illustrating navigation described in FIG. 2;

FIG. 4 is a flowchart showing an example method for users to navigate on relatively small user interfaces according to FIGS. 5A-5J;

FIGS. 5A-5J show example displays illustrating navigation described in FIG. 4; and

FIG. 5K shows one example set-up of a notifications system on the user interface.

### DETAILED DESCRIPTION OF THE ILLUSTRATED EMBODIMENTS

In the following detailed description, reference is made to the accompanying drawings where like numerals represent like details. The embodiments are described in sufficient detail to enable those skilled in the art to practice the invention. It is to be understood that other embodiments may be utilized and that changes may be made without departing from the scope of the invention. The following detailed description, therefore, is not to be taken in a limiting sense and the scope of the invention is defined only by the appended claims and their equivalents. In accordance with the features of the invention, systems and methods for optimizing display space of an imaging apparatus user interface are described herein.

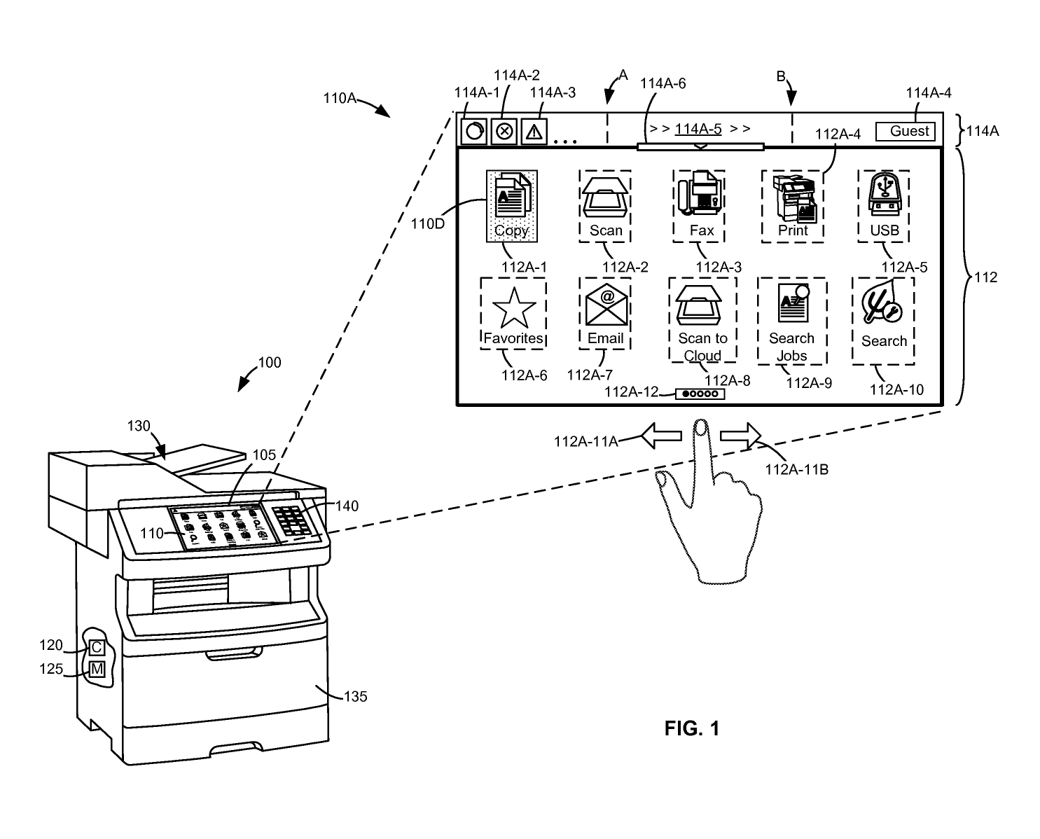

FIG. 1 shows imaging apparatus 100 including user interface 105 for generating display 110 thereon for manipulation by a user in indicating preferred options in executing a function, such as printing (represented by “Print” icon 112A-4). Besides printing, imaging apparatus 100 may be capable of performing other functions such as copying (icon 112A-1), scanning (icon 112A-2), faxing (icon 112A-3), reading files from USB (icon 112A-5), accessing forms (icon 112A-6), e-mailing documents (icon 112A-7), scanning documents to cloud (icon 112A-8), searching active jobs or processes on imaging apparatus 100 (icons 112A-9), and configuring imaging apparatus 100 to reduce energy use and/or supply consumption (icon 112A-10). Imaging apparatus 100 may be, for example, a laser printer, a copy machine, an inkjet printer, a dot-matrix printer, or a multifunction product (MFP) including user interface 105.

Imaging apparatus 100 includes controller 120 for controlling different components that are integrated to or operatively connected with the imaging apparatus and memory 125. Memory 125 is a non-transitory computer-readable medium used for storing one or more program instructions having logic that directs components of imaging apparatus 100 to operate in a particular manner, such as, for example, a hard drive. Controller 120 may communicate with memory 125 for the program instructions and use the instructions for controlling one or more processes on imaging apparatus 100 which includes execution of functions, communicating with other devices and other like processes. Alternatively controller 120 may be embedded with program instructions for execution thereon. Controller 120 may be typified, for example, as a microprocessor an electronic circuit, an Application-Specific Integrated Circuit (ASIC) or other suitable forms of processing media.

Components that are managed by controller 120 include hardware and/or software components. Hardware components include user interface 105, automatic document feeder 130 and media input tray 135; while software components include the program instructions stored in memory 125 and/or controller 120 for execution such as display 110 and other modules apparent in the art embodied on any imaging apparatus 100. These components may be communicatively coupled over a shared data bus for communication with each other. Besides user interface 105, imaging apparatus 100 may also include other components for users to interface with, such as, for example, key panel 140 including number keys, arrow keys, and other operation-related keys (e.g., “Back” button 141 and “Start” button 142) for manipulation by the user, as well as other like interfacing mechanisms.

Display 110 is any graphical display on user interface 105 generated from program instructions stored in memory 125 and executed by controller 120. The program instructions may be integrated to imaging apparatus 100 upon manufacturing process thereof. Controller 120, in communication with memory 125, may be configured to determine which type of display 110 and/or what GUI elements to be displayed or removed on user interface 105 based on logic of the stored program instructions.

Display 110 includes GUI elements which may be, for example, a button, a tab, a pane, a caption, an icon, combo boxes, text boxes, a slider or track bar, a toggle switch or box, a pop-up window, arrows, and like elements for user manipulation. GUI elements on display 110 may be manipulated using hand gestures which can take the form of a tap and double tap, a hook and drag, a swiping gesture, pinching or other gestures known in the art of touch screen interaction. Alternatively, GUI elements may be manipulated by clicking of a mouse, contacting through a stylus, and similar methods of user interfacing.

On a structural note, user interface 105 comprises a display monitor including touch-sensitive surfaces or layers for the user's fingers to come into contact with or tap on. In the present disclosure, user interface 105 is a capacitive touch screen absorbing electrical charge from impact locations of the user's fingers or tips thereof, wherein the impact location/s may be directed to a particular GUI element on the screen. In an alternative embodiment, user interface 105 may be comprised of multiple protective screen layers operating based on a pressure applied thereon by any pointed objects wielded by the user. Controller 120 is configured to determine which GUI element(s) generated on user interface 105 is/are affected by the user's gestures thereon. With reference still on FIG. 1, user interface 105 generates home screen display 110A for users to select a desired function to be executed on imaging apparatus 100.

Home screen display 110A may be generated on user interface 105 upon first power on of imaging apparatus 100 (e.g., using “Start” button 142), upon resumption of imaging apparatus 100 after hibernation, or upon selection of a “Home” button from a portion of user interface 105 or from key panel 140 configured to display home screen display 110A. Home screen display 110A as well as any other displays 110 for display on user interface 105 includes top 110-1, bottom 110-2, and left and right sides (110-3 and 110-4, respectively) that altogether defines the display area in which GUI elements are to be confined. In the present disclosure, home screen display 110A includes main panel 112A including a plurality of captioned icons 112A-1 to 112A-10 that each correspond to a respective function imaging apparatus 100 may be capable of performing, namely: “Copy” icon 112A-1, “Scan” icon 112A-2, “Fax” icon 112A-3, “Print” icon 112A-4, “USB” icon 112A-5, “Forms” icon 112A-6, “E-mail” icon 112A-7, “Scan to Cloud” icon 112A-8, “Search Jobs” icon 112A-9, and “Eco-Settings” icon 112A-10. Captioned icons 112A-1 to 112A-10 may be arranged in a particular manner on main panel 112A, such as in a grid format or in a scrollable list view.

How icons 112A-1 to 112-10 and other information on home screen display 110A are to be arranged is limited within such display area. For example, icons 112A-1 to 112A-10 are initially displayed on home screen display 110A. If other contents (i.e., captioned icons, information relating to imaging apparatus 100 itself or events thereon, etc.) are to be shown on home screen display 110A, the currently displayed set of contents on main panel 112A (captioned icons 112A-1 and 112A-10) is operative to be scrolled across user interface 105 to show another set of contents. Moving between a first set of content and a second set of content on main panel 112A can be performed by dragging a portion of main panel 112A from left to right or vice-versa of the display, as suggested by left and right arrows 112A-11A and 112A-11B respectively. A scrolling indicator (112A-12) may be provided on main panel 112A to indicate an extent of user interface 105 that may be scrolled or a length of user interface 105 to which content on main panel 112A may be panned. Of course, other embodiments of a home screen display besides that depicted by home screen display 110A will be apparent in the art.

As each of captioned icons 112A-1 to 112A-10 is representative of a function imaging apparatus 100 is configured to perform, each icon is operative to be selected independently. Upon generation of home screen display 110A, controller 120 detects whether any of captioned icons 112A-1 to 112A-10 has been selected by a user. A user of imaging apparatus 100 can “select” any captioned icon on home screen display 110A (or any GUI element on any display 110 for that matter), through gestures, as discussed. When controller 120 detects that a captioned icon has been selected, the selected captioned icon is indicated—i.e., highlighted in a shaded box as depicted by “Copy” icon 112A-1 on FIG. 1—on user interface 105. Other methods in selecting a function to be executed on imaging apparatus 100 are apparent to skilled artisans.

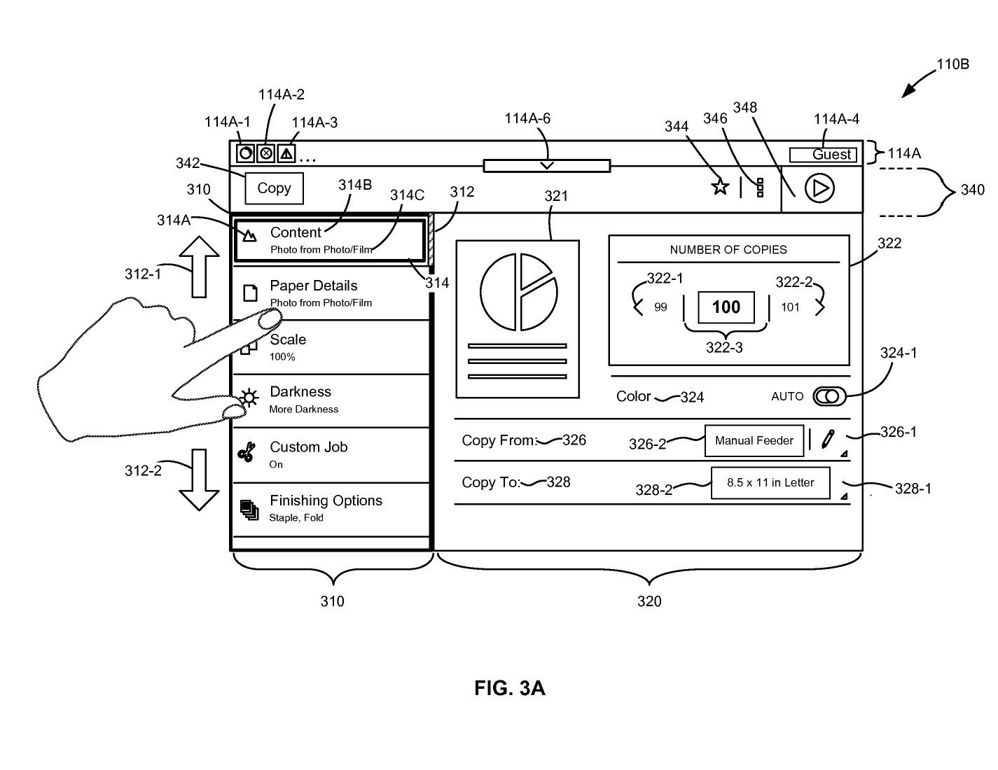

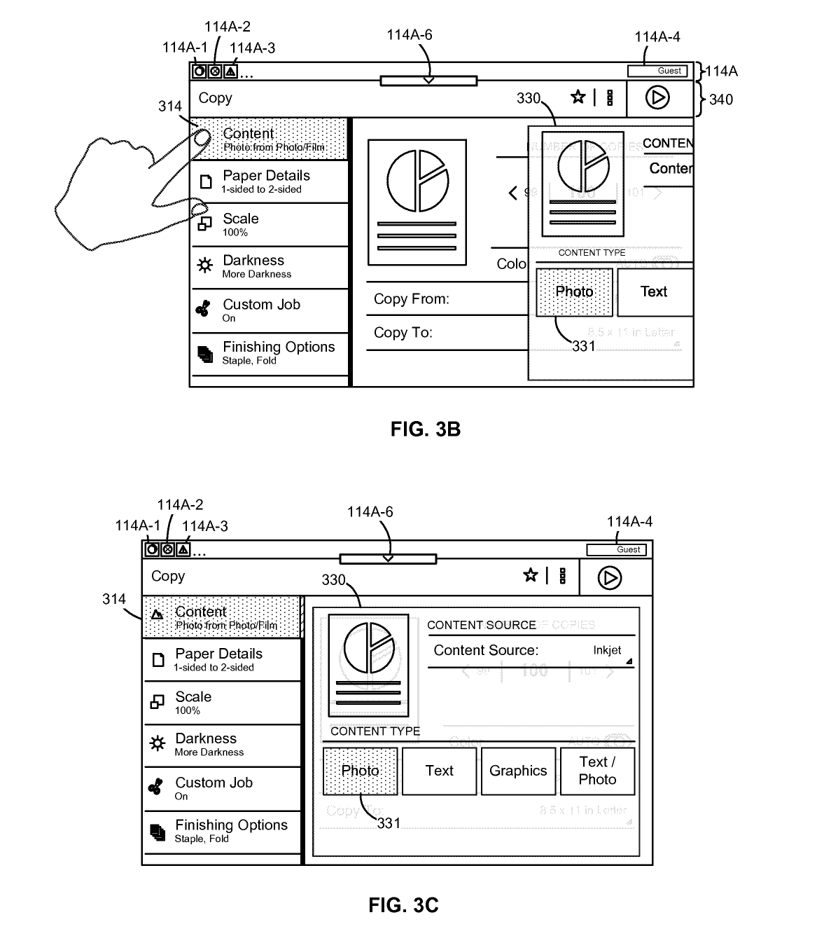

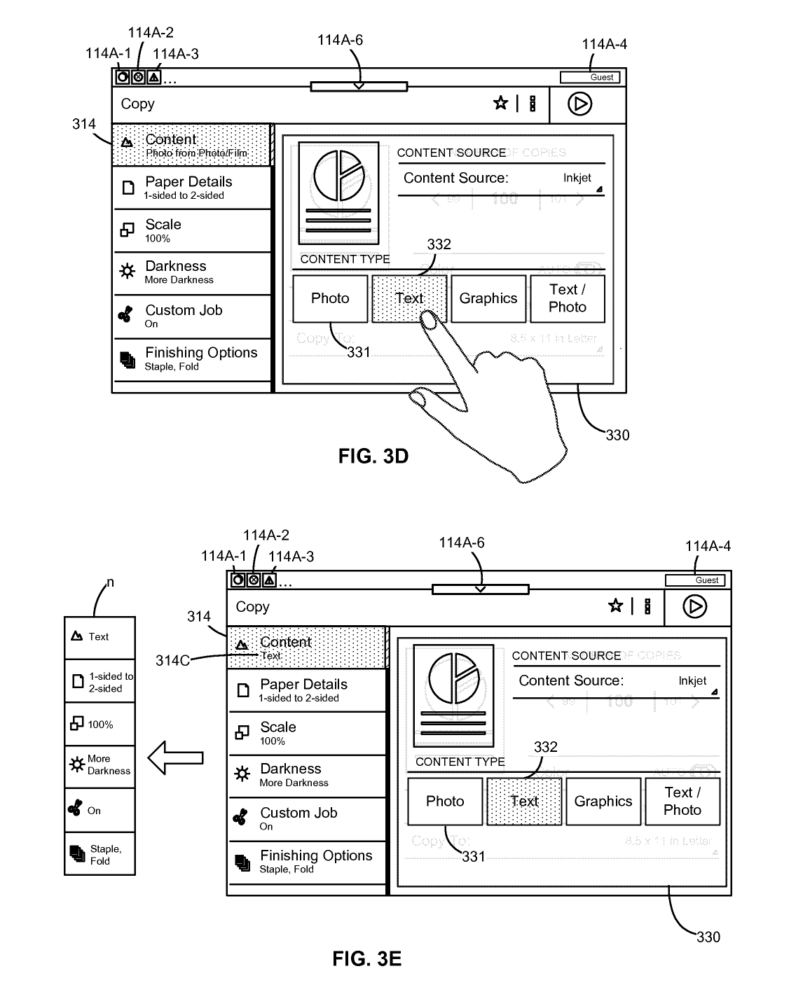

In response to detecting selection of a function in the form of selecting one of captioned icons 112A-1 to 112A-10 on home screen display 110A, a function landing screen display is generated. A function landing screen display refers to one type of display 110 containing the plurality of settings and options associated with the selected function each embodied in a GUI element, as typified in the following embodiments. Regardless of whether for relatively large or relatively small sizes of user interface 105, a function landing screen display features an optimal arrangement of settings and associated options on user interface 105 for user viewing and manipulation. Since the number of elements that may be generated or displayed on user interface 105 is dependent on a size or available display space thereon, different function landing screen displays are generated for relatively large user interfaces (i.e., function landing screen display 110B) and for relatively small user interfaces (i.e., function landing screen displays 110C, 110D). As will be depicted in FIGS. 3A-3E, function landing screen display 110B bifurcates user interface 105 into two portions—settings pane 310 lists the plurality of settings associated with the user-selected function while adjacent to it is preset pane 320 featuring a preconfigured set of settings and options for the same function. Transparent drawer 330 is operative to be launched and hovered or closed over preset pane 320 for displaying other specific settings and/or options associated with settings from settings pane 310, as will be discussed herein. For relatively small user interfaces, function landing screen display 110C is first generated for displaying the preconfigured set of settings and options for user selection (i.e., preset pane 520) and a link (i.e., “Settings” button 505) for use in launching a second function landing screen display (function landing screen display 110D). Similar to function landing screen display 110B, function landing screen display 110D bifurcates a display area thereof into two portions in the form of a resizable settings pane 510.

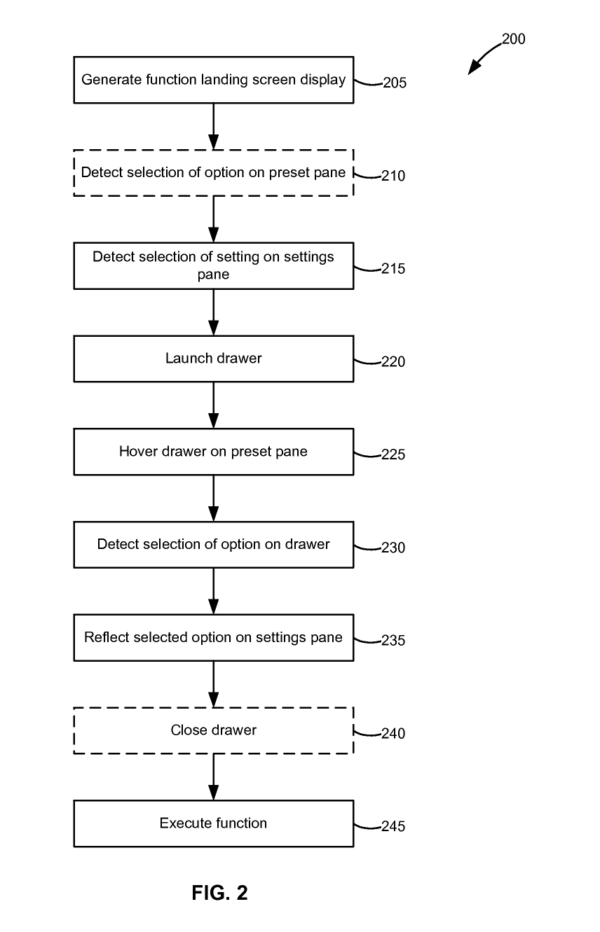

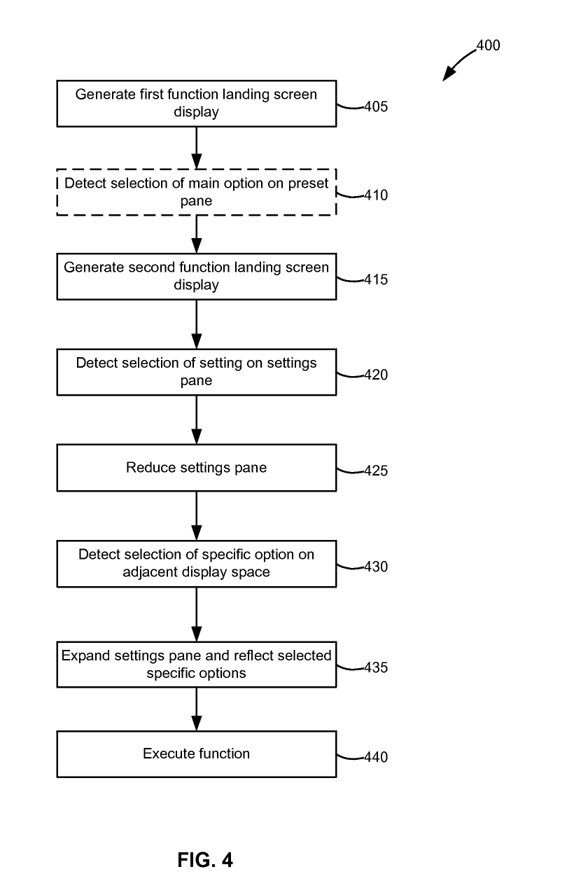

How relatively large or relatively small a user interface (105) of a particular imaging apparatus is may be categorized by an organization. More particularly, how relatively large or small a user interface (105) may be may be dependent on its display resolution or how many graphical pixels can be accommodated thereon. Relatively large user interfaces for Lexmark's next-generation multifunction products (MFPs), for example, are those that have a length of substantially 7 inches, while sizes for relatively small user interfaces are those that have a length of substantially 4.3 inches, horizontal-wise. Methods in generating function landing screen displays 110B, 110C, and 110D and their respective GUI elements on user interface 105 for users to indicate preferred options in executing a selected function are performed by controller 120 and detailed by flowcharts 200 and 400 in respective FIGS. 2 and 4.

### Function Landing Screen Displays for Relatively Large User Interfaces

In FIG. 1, when controller 120 detects the selection of “Copy” icon 112A-1 in home screen display 110A, “Copy” function landing screen display 110B is generated on user interface 105 for receiving preferred options from users in executing the “Copy” function (block 205, FIG. 2). As depicted in FIG. 3A, in generating function landing screen display 110B, controller 120 bifurcates into two portions a display area of user interface 105 being defined by the distance between left side 110-3 and right side 110-4. Specifically, the display area of user interface 105 is bifurcated into two portions vertically such that the two resulting portions consist of a first portion being disposed adjacent to left side 110-3 (i.e., typified by settings pane 310) and a second portion being disposed adjacent to right side 110-4 (typified by preset pane 320). As depicted in FIG. 3A, each of settings pane 310 and preset pane 320 is simultaneously visible to the user on user interface 105 and is operative to be independently manipulated.

Settings pane 310 includes settings associated with the function selected by the user. Each setting on settings pane 310 is an independent graphical element (i.e., setting tab 314N, with N referring to a positioning of the list of settings on settings pane 314) for selection. Selecting a setting can be performed by the user through selecting a desired setting tab 314N on settings pane 310. For identifying the setting a particular setting tab 314 is representative of, each setting on settings pane 310 may include information associated with the setting. Accordingly, each setting tab 314N includes at least one of icon 314N-1 and text 314N-2 for identifying the setting the said tab is representative of. Other types of identifiers may also be included for identifying the setting tab 314 is representative of such as, for example, a logo or other graphical elements. Additionally, each setting tab 314 includes text or option identifier placeholder 314N-3 indicating a default option and/or a user-selected option for the same setting. Text 314N-3 may be operative to change when a selection is made by the user on drawer 330. For example, while a drawer 330 is executing adjacent to a selected setting tab 314N, controller 120 determines whether any option besides the default option associated with the selected setting tab has been selected by the user. Upon a positive determination, controller 120 automatically indicates the selected option as text 314N-3 in the selected setting tab 314N in replacement of the default option or an option selected at a previous instant for storage in memory 125 and use in executing the selected function. Settings pane 310 may further include scrollbar 312 operative to allow a user to scroll through the settings thereon; scrollbar 312 may be utilized by the user to move through the settings on settings pane 310 in an up and down motion, as suggested by up arrow 312-1 and down arrow 312-2. With reference back on FIG. 1, “Copy” function may be selected by the user through selection of “Copy” icon 112A-1 on home screen display 110A. In the present disclosure, each setting associated with the “Copy” function is referred to as setting tab 314N with the corresponding information thereon as icon 314N-1, text or setting identifier 314N-2, and text or option identifier placeholder 314N-3. As depicted thereon, settings associated with the “Copy” function may include, for example, “Content” setting tab 314A, “Paper Details” setting tab 314B, “Scale” setting tab 314C, “Darkness” setting tab 314D, “Custom Job” setting tab 314E, “Finishing Options” setting tab 314F, and other similar settings 314N.

Adjacent to settings pane 310 in FIG. 3A is preset pane 320. Preset pane 320 includes another set of settings associated with a selected function and options associated with each of the settings for selection. In contrast to settings on settings pane 310, settings on preset pane 320 include a preconfigured set of featured, commonly used, or predetermined to be the most important settings for the user-selected function. In the same example, preset pane 320 for the “Copy” function may include copy number setting 322, color setting 324, copy source setting 326, and copy destination setting 328 (besides image 321 representative of the input document) as the number of copies, how the input document may be produced, and the source and destination of the input and output documents, respectively, are often the essential aspects to be determined prior to executing the selected function. Each of settings 322, 324, 326, and 328 on preset pane 320 includes respective option selectors 322-1 and 322-2; 324-1; 326-1; and 328-1, respectively positioned next to it. An option selector may refer to any GUI element for enclosing all the preconfigured options to choose from that are associated with a setting (may it be on settings pane 310, preset pane 320, or drawer 330). An option selector is further operative to respond to user input or gestures and may be, for example, a toggle combo box, a drop-down combo list, a text box, and like GUI selector elements for dynamically generating options for user selection.

In other example embodiments where options to be selected are minimal in number, the said options may be presented all at once or at one time on the corresponding portion in the executing display for users to view and select on. As such, the same options may not be embedded in an option selector. In FIG. 3C for instance, “Content Type” setting 333 associated with the “Content” setting on settings pane 310 may only be consisted of four options for users to choose from, namely: “Photo” option 333-1, “Text”, option 333-2, “Graphics” option 333-3, and “Text/Photo” option 333-4. As such, when “Content” setting tab 314 is detected by controller 120 to be selected by the user in settings pane 310, the said four options may be displayed next to each other for users to view simultaneously and select on instead of being altogether embedded into an appropriate option selector.

With reference back on FIG. 3A, each option selector on preset pane 320 (or on any type of display 110) may indicate an option next to it, as depicted by identifiers 322-3, 324-2, 326-2 and 328-2 for copy number setting 322, color setting 324, copy source setting 326, and copy destination setting 328, respectively, enclosed in boxes. Initially or upon execution of function landing screen display 110B, each of identifiers 322-3, 324-2, 326-2 and 328-2 may display a default or preset option for the setting it is associated with. For example, the default option for copy source setting 326 is the “manual feeder” option as indicated by identifier 326-2.

While function landing screen display 110B is executing on user interface 105, controller 120 detects whether or not an option besides the default option is selected on preset pane 320 through their respective options selectors (optional block 210, FIG. 2). Each of option identifiers 322-3, 324-2, 326-2 and 328-2 adjacent to corresponding settings 322, 324, 326 and 328 are operative to be changed when another option has been selected by the user (i.e., preferred option) through respective option selectors 322-1 and 322-2; 324-1; 326-1; and 328-1. For example, a user may prefer to increase a number of copies to be produced for an input document from the displayed default option “100” on identifier 322-3. Copy number option selectors less-than sign 322-1 and greater-than sign 322-2 may be used to indicate the preferred decrease or increase in the copy number relative to the option displayed on identifier 322-3. For example, to indicate the preferred decrease in the number of document copies from the option identifier 322-3, users are required to tap less-than sign 322-1. Otherwise, to indicate the preferred increase in the number of document copies relative to the default or currently selected option 322-3, greater-than sign 322-2 is available for selection.

In the same context, controller 120 is configured to determine a number of times or a length of time the user's fingers has contacted with either of the two signs. For example, a single tap on greater-than sign 322-2 may be interpreted by controller 120 as a desired increase of one in the copy number shown on identifier 322-3. In other example embodiments, the length of time the user's finger(s) came into contact with an option selector may be used to determine the preferred increase or decrease in the number of copies to be produced for the input document. As such, for each second that a user's finger is in contact with less-than sign 322-1, the number of copies indicated on identifier 322-3 may be decreased by one, depending on how the option selectors are programmed to operate on user interface 105.

In another example still on FIG. 3A, the toggle combo box adjacent to copy destination setting 328 may be copy destination option selector 328-1. When it has been detected by controller 120 that a user's finger has contacted with copy destination option selector 328-1, another text option is displayed on option 328-2, such that at each time the user's finger contacts with copy destination option selector 328-1, option identifier 328-2 changes. Alternatively, copy destination option selector 328-1 may be a drop-down combo box operative to generate a list of preconfigured options to choose from for users to select a preferred option. Generating the list may be performed in a scrollable, drop-down manner. In another example, option selector 324-1 associated with color setting 324 may be a toggle switch operative to be swiped to the right or left for changing the option indicated on adjacent option identifier 324-2 (e.g., “Auto”). Regardless of the nature of operation of an option selector, any selection of options made by the user on preset pane 320 are detected by controller 120 and stored into memory 125 for use in executing the function at a later instance. It may also be apparent in the art that the option selection step of block 210 (flowchart 200, FIG. 2) may be performed at any time while function landing screen display 110B is shown on user interface 105 prior to execution of the selected function.

While function landing screen display 110B is on display on user interface 105, controller 120 detects whether or not a particular setting tab 314N is selected by the user on settings pane 310 (block 215 of FIG. 2). Selection of setting on settings pane 310 is also performed by tapping on a desired setting tab 314N on settings pane 310. Upon an affirmative detection, the selected settings tab 314N is highlighted on settings pane 310, which is depicted in FIG. 3B as “Content” setting tab 314A filled with a bunch of dots. In FIG. 3B, consequent to such selection, drawer or specific options pane 330 is launched (block 220, FIG. 2). In the present disclosure, drawer 330 is another pane on user interface 105 for independent user manipulation. In contrast to the preset settings and options on preset pane 320, drawer 330 includes a number of options specifically associated with the selected setting tab 314N on settings pane 310 and/or other more specific settings associated with the selected setting tab. For example, when “Content” setting tab 314A is selected by the user on settings pane 310, drawer 330 may include “Content Source” 332 and “Content Type” 333 settings that are both related to the “Content” setting. As shown from FIGS. 3C to 3E, adjacent to “Content Source” setting 332 are content source option selector 332-1 for allowing users to go through each available option for the said setting and option identifier 332-2 that displays the user-selected option. Similar to preset pane 320, option identifier 332-2 on drawer 330 may initially display or highlight upon launching thereof, the default or preconfigured option for specific setting 332. For example, “Inkjet” may be configured as the default option for the “Content Source” setting and this is indicated in option identifier 332-2.

Drawer 330 has an area substantially equal to that of preset pane 320 such that, for example, an area of drawer 330 is within bounds of preset pane 320 for distinguishing drawer 330 from preset pane 320. Additionally, drawer 330 has a transparent surface such that contents on preset pane 320 (i.e., copy number setting 322, color setting 324, copy source setting 326, and copy destination setting 328; corresponding option selectors 322-1 and 322-2, 324-1, 326-1 and 328-1; and option identifiers 322-3; 324-2; 326-2; and 328-2, respectively) are substantially recognizable when drawer 330 hovers over preset pane 320. Considering its transparency, drawer 330 allows the same content on preset pane 320 (grouped as content 331, FIGS. 3B-3E) to be seen through by users.

With reference still on FIG. 3B, drawer 330 is operative to be launched in a sliding manner from a side of user interface 105 when a particular setting tab 314N is selected from settings pane 310. As shown from FIG. 3B-3C, drawer 330 may be operative to move from right side 110-4 of function landing screen display 110B, such that when one setting tab 314 is selected from settings pane 310, a corresponding drawer 330 glides from right side 110-4 until it reaches a position adjacent settings pane 310 (FIG. 3B) and hovering only over preset pane 320 (see FIG. 3C) (block 225). Since the plurality of settings associated with a selected function is available on settings pane 310, there is no need for users to navigate between different displays in the user interface to select settings. Further, as drawer 330 is dynamically launched adjacent to settings pane 310 and at the same time provides a view of preset pane 320 underneath it, users will be able to choose a setting and select specific, preferred options in executing the selected function without getting lost while still having a view of the preset content 331, as are the problems in prior user interfaces for an imaging apparatus.

As long as drawer 330 is open or hovering over preset pane 320, controller 120 detects whether or not there is a selection of any option thereon. When controller 120 detects a change in option on any option selector on drawer 330 (block 230), the newly-selected option is configured to be now highlighted instead of the default or previously selected option. Simultaneously, the newly-selected option replaces the option reflected on text or option identifier placeholder 314N-3 from the setting tab associated with the drawer (block 235). With reference in FIG. 3C, “Photo” option 333-1 may be initially set as the default option for the “Content” setting tab 314A on setting pane 310 as indicated in option placeholder identifier 314A-3 and as highlighted on a shaded box in drawer 330. When it has been determined by controller 120 in FIG. 3D that another option (i.e., “Text”) has been selected by the user in drawer 330 (shown as index finger hovering over “Text” option 333-2), the selected option is automatically highlighted on drawer 330. Simultaneously in FIG. 3E, an identifier of the selected option replaces the option indicated on text 314A-3. In this way, any selection of option made by the user on drawer 330 is automatically reflected on the corresponding setting tab 314N (specifically on text 314N-3) on settings pane 310 for referencing of the users.

Upon detecting any option selection from drawer 330, controller 120 immediately stores the selected option in memory 125. Storing the selected option in memory 125 is performed implicitly from the user, such that the user is not informed about such storage through notifications on user interface 105. As such, time is saved, in the form of controller 120 determining the preferred options of the users in executing the selected function.

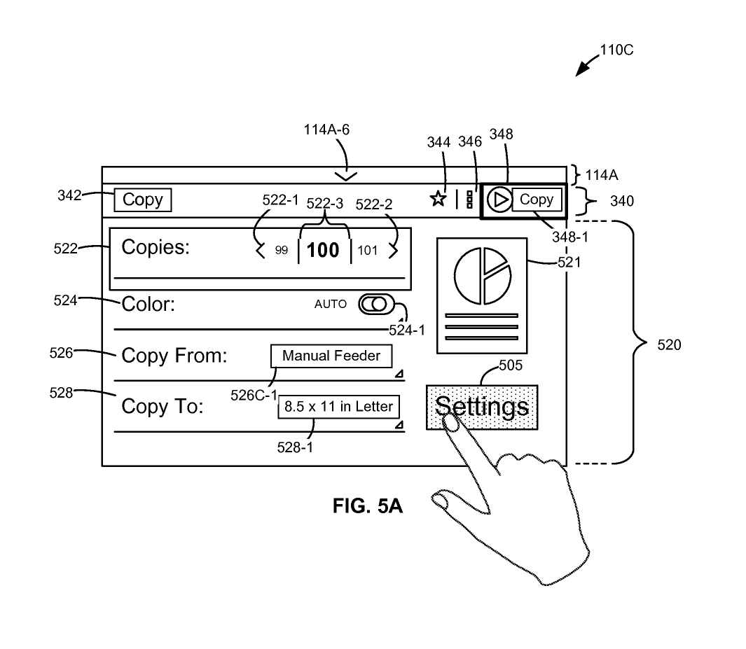

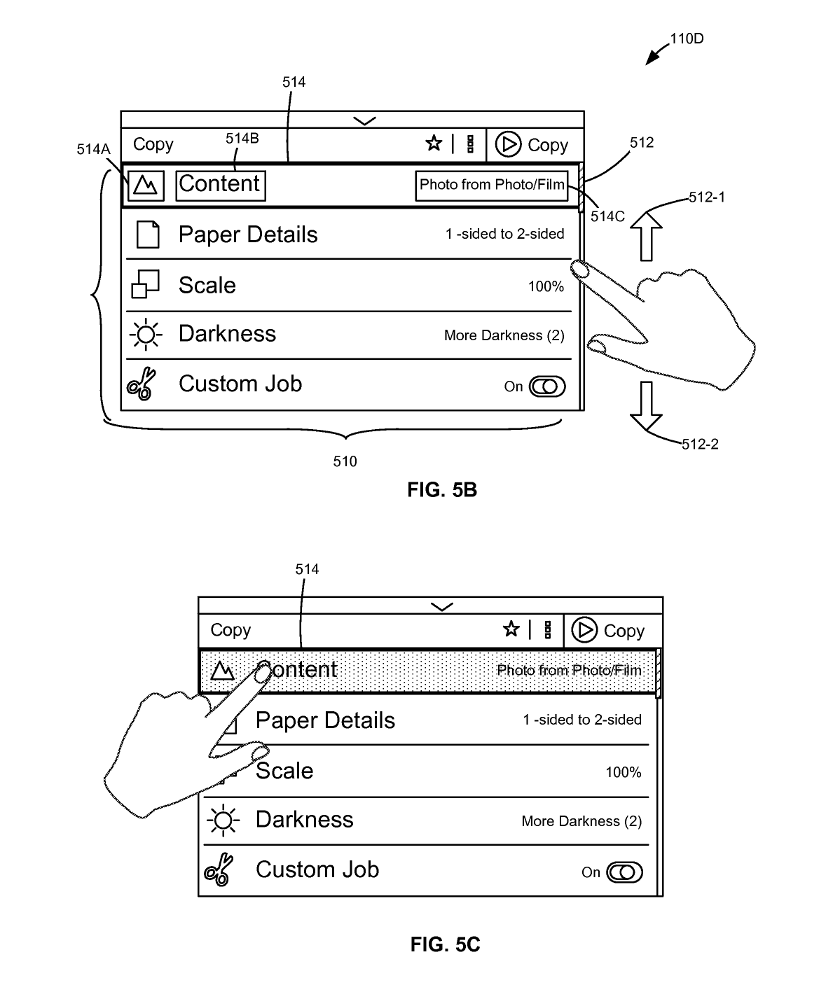

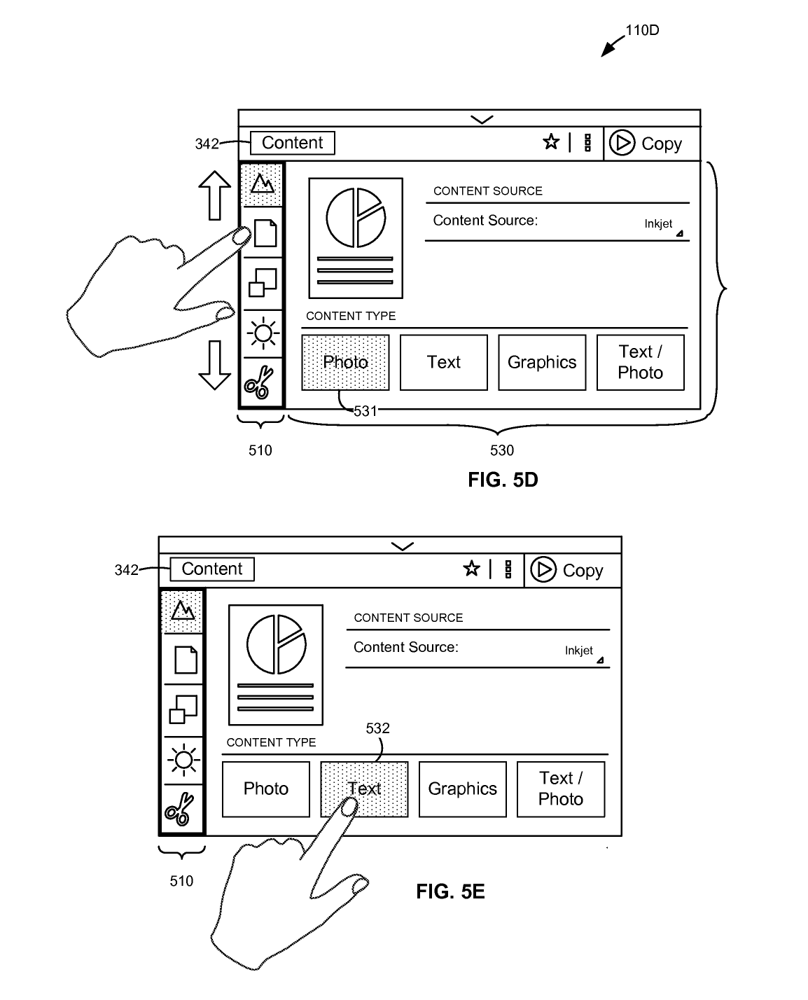

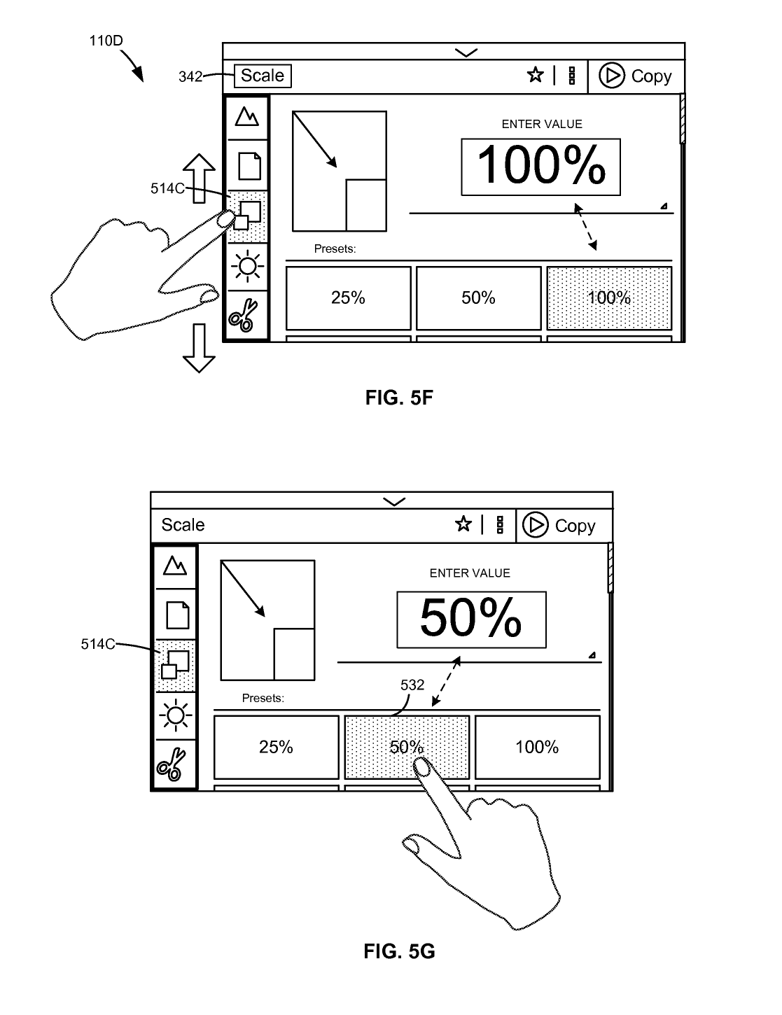

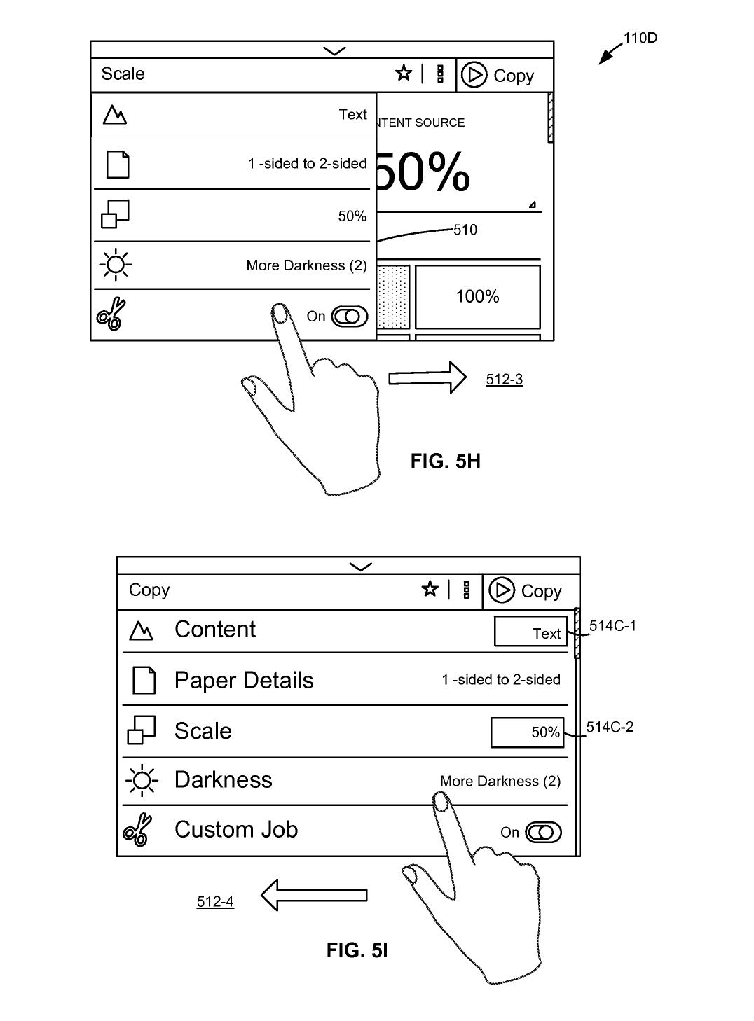

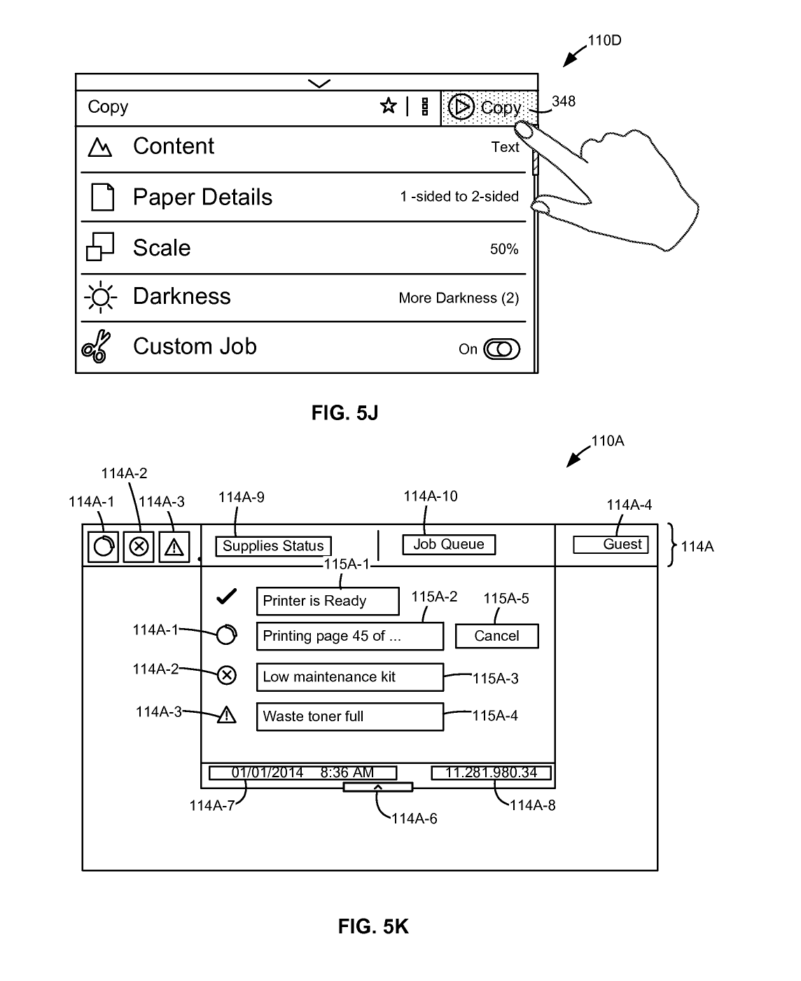

While drawer 330 is operative to be launched when one setting tab 314 is selected by the user, drawer 330 is also operative to be closed or configured to be not shown on user interface 105 (optional block 240). Closing drawer 330 may be performed through three example methods. In a first example method, controller 120 may be configured to detect for a selection of “Back” button 141 on key panel 140 of FIG. 1 or other graphical buttons (i.e., “Back” button 349 on control bar 340, FIGS. 3A and 5A) provided on a portion of any display 110 for allowing users to close drawer 330. In another example method for closing drawer 330, controller 120 may detect for any swiping gesture on user interface 105 from drawer 330. The swiping gesture may be, while the user's fingers are contacting with drawer 330, directed to right side 110-4 of user interface 105. Third, controller 120 may further be configured to detect whether the user deselected said one highlighted setting tab 314N corresponding to drawer 330 in order to close the drawer. In this context, the selection and deselection of a particular setting tab 314N may trigger the launching and closing of drawer 330, respectively.

Another setting 314N may be selected on settings pane 310 and simultaneously a corresponding drawer 330 may be launched. For example, the user may next select “Scale” setting tab 314C or “Darkness” setting tab 314D. Regardless, controller 120 detects this change in the desired setting and consequently display associated drawer 330 for displaying the options that users may choose from. Controller 120 then detects any selection of options on drawer 330 made by the user, implicitly stores it to memory 125 and reflects the selected option as text on the appropriate text or option identifier placeholder 314N-3. In FIG. 3E, since selected options are displayed on appropriate text 314N-3 on settings pane 310 and settings pane 310 is constantly made available to the users prior to executing a predetermined function, summary 316 of the selected options is provided to the user prior to executing any function in the sense that the preferred options can be viewed by users at one-time on the user interface. It may be apparent in the art that the user may continue to perform blocks 210-240 prior to execution of the function until all the preferred options in executing the function has been selected on the function landing screen display.

The selected function from home screen display 110A may then be executed based on the options reflected on settings pane 310 (block 245). As selected options are neatly summarized as summary 316 on the constantly available settings pane 310 regardless whether or not selection of other options on drawer 330 is ongoing, the need to move between different displays 110 on user interface 105 is also being eliminated. Controller 120 detects whether the user's finger contacts with execute button 338 to activate execution of the function. Of course, other elements on user interface 105 may be utilized to activate or start execution of the function, such as, for example, “Start” button 142 on key panel 140.

### Function Landing Screen Displays for Relatively Small User Interfaces

Detailed in flowchart 400 on FIG. 4 is another method on how to optimize a user's interfacing experience on user interfaces 105 that are relatively small in size. Since relatively small user interfaces have more limited display space(s), settings and corresponding options associated with the selected function for display still gets bifurcated on user interface 105. While settings pane 310 and preset pane 320 are executing simultaneously on relatively large user interface(s) 105, content 331 on preset pane 320 and settings on settings pane 310 are delegated into two separate function landing screen displays, namely, function landing screen display 110C and 110D, respectively. Function landing screen display 110C typifies preset pane 320 taking up all display area of the user interface (FIG. 5A) and leading to function landing screen display 110D typified by resizable settings pane 510 operative to initially take up the display area of the user interface and be reduced to one side of user interface 105 for giving space to display area 530 (FIGS. 5D-5G). It is to be noted that corresponding option selectors on function landing screen displays 110C and 110D are operative to be manipulated in the same manner as they are manipulated on relatively large user interface(s) 105 or as known in the art by skilled artisans.

Similarly, upon detection by controller 120 that a function has been selected by the user to be performed on imaging apparatus 100, a function landing screen display (110C) is generated on user interface 105 (FIG. 5A) (block 405). Function landing screen display 110C acts as the primary display for relatively small user interfaces and includes substantially the same preconfigured set of content (331) to that of preset pane 320 of function landing screen display 110B. With reference back on FIG. 1, when it has been determined by controller 120 that the “Copy” function is desired by the user to be performed on imaging apparatus 100 through selection of “Copy” icon 112A-1, function landing screen display 110C in FIG. 5A generates thereon the preconfigured settings and options associated with the selected “Copy” function, such as, for example (besides image 521 representative of the input document), copy number setting 522, color setting 524, copy source setting 526, and copy destination setting 528 each having respective option selectors 522-1 and 522-2; 524-1; 526-1; and 528-1 adjacent thereof for users to utilize in selecting preferred or desired options. Similarly with preset pane 320 on function landing screen display 110B, content on function landing screen display 110C—inclusive of settings and options—may be those settings that are identified to be more commonly modified by users or those that are identified to be the primary ones. In generating function landing screen display 110C first, users are allowed to indicate preferred options for the primary set of settings associated with the selected function prior to proceeding with the specific set of settings and associated options of the selected function. Controller 120 also detects whether options have been selected or changed by the user on function landing screen display 110C through respective option selectors 522-1 and 522-2; 524-1; 526-1; and 528-1 thereon (optional block 410). Upon such detection, the newly-selected options are immediately stored to memory 125 and reflected on respective option identifiers 522-3, 524-2, 526-2, and 528-2 for use in executing the selected function.

With reference still on FIG. 5A, function landing screen display 110C also includes a link, such as a GUI element (e.g., “Settings” button 505) operative to be used to generate another function landing screen display (110D) that includes the specific set of settings and options of the same selected function. Regardless of whether or not any option has been changed in function landing screen display 110C, when controller 120 detects that the user selected “Settings” button 505 (as depicted by an index finger contacting “Setting” button 505), function landing screen display 110D is generated on user interface 105 (block 415).

Now in FIG. 5B, function landing screen display 110D is comprised of a resizable settings pane (510) which includes substantially the same content to that of settings pane 310 of function landing screen display 110B for relatively large user interfaces. Resizable settings pane 510 initially takes up the display area of the user interface defined by top 110-1, bottom 110-2, and left and right sides 110-3 and 110-4, respectively. Likewise, each setting included in settings pane 510 is to be treated as an independent setting tab 514N or any other similar GUI element for selection of a user that may include an icon 514N-1, text 514N-2 identifying the setting, and/or text or option identifier placeholder 514N-3 identifying the default or user-selected option for the same setting tab. When it has been determined by controller 120, for example, that the user wishes to perform the “Copy” function on imaging apparatus 100 through detecting selection of “Copy” icon 112A-1 from FIG. 1, function landing screen display 110D generates settings and options associated with the selected “Copy” function. In FIG. 5B, for example, “Content” setting tab 514A, “Paper Details” setting tab 514B, “Scale” setting tab 514C, “Darkness” setting tab 514D, “Custom Job” setting tab 514E, and “Finishing Options” setting tab 514F are generated on the user interface. Similarly, the said settings are operative to be scrolled upwards or downwards when taken as a whole, as suggested by up arrow 512-1 and down arrow 512-2 in FIG. 5B. Scrollbar 512 may be utilized to perform the scrolling.

Upon detecting that one setting tab (514) on resizable settings pane 510 has been selected by the user at a first instance function landing screen display 110D is being generated on user interface 105 (block 420), controller 120 highlights the selected setting tab. In FIG. 5C, for example, the user selects “Content” setting tab 514A and “Content” setting tab 514A in turn is highlighted or shaded. Further, settings pane 510 is not only operative to be scrolled in an up and down motion (FIG. 5B) but is also operative to be resized when a setting tab thereon has been selected. Specifically, settings pane 510 automatically reduces its width (defined by the distance between left side 110-3 to right side 110-4 of function landing screen display 110D) (block 425). As depicted from FIGS. 5D-5G, settings pane 510 is operative to be automatically positioned to one side (i.e., to left side 110-3) of user interface 105 in addition to highlighting the selected setting tab. With settings pane 510 being smaller, information associated with each setting may be decreased, leaving out only the respective icons 514N-1 instead of having all of the setting and option identifiers (icon 514N-1, text 514N-2, and text 514N-3). Alternatively, other graphical identifiers that do not take a lot of space may be used to identify each setting when settings pane 510 is being reduced. Even in its reduced state, resizable settings pane 510 is still operative to be scrolled across an area of user interface 105 to allow viewing of all specific settings or icons 514-1 associated with the function—with or without scrollbar 512, as suggested by up and down arrows 512-3 and 512-4, respectively (shown in FIGS. 5D).

Thus, with settings pane 510 being reduced, a display area (530) is made available adjacent to it on user interface 105 for accommodating specific options associated with the selected setting corresponding to any selected setting tab 514N. This way, any icon 514N-1 representative of a specific setting associated with the selected function can be selected on resizable settings pane 510, and options associated with the selected icon/setting can be simultaneously viewed and selected by users on display area 530 adjacent to it. Such specific options to be presented on display area 530 for relatively small user interfaces are to be noted as the same options to be presented on drawer 330 for relatively large user interfaces and still depend on the selected setting from settings pane 510 embodied by selection of an icon 514N-1 thereon. When a collective content on display area 530 cannot be contained within its limits on user interface 105 (limits being defined as the area available for generating GUI elements), display area 530 is operative to be scrolled upwards or downwards. In FIGS. 5F-5H, for example, scrollbar 531 is made available to perform upwards and downwards scrolling, for example, as is suggested by up arrow 512-5 and down arrow 512-6 in FIG. 5F.

Since icons that correspond to the selected function can be selected from resizable settings pane 510 anytime and content for display on display area 530 is dynamically changed depending on the selected icon on settings pane 510, users can select a setting specific to a function and preferred options without having to move through a number of displays on user interface 105, similar to how drawer 330 improves the user's experience with regards to selecting preferred options on relatively large user interfaces. With reference back to FIG. 5C, when “Content” setting tab 514A has been determined by controller 120 to be selected from the (expanded) settings pane 510, settings pane 510 is being reduced to accommodate specific options associated thereof. Consequently, in FIG. 5D, “Content” icon 514A-1 on the reduced settings pane 510 is being highlighted and a set of content associated with the “Content” setting are generated on display area 530. Said content associated with the selected “Content” setting tab from FIG. 5C may include the following: “Content Source” setting 532 and “Content Type” setting 533 with respective options to choose from as displayed thereon.

Default options are indicated on display area 530. For example, “Content Source” setting 532 may indicate “Inkjet” on option identifier 532-2 as its default option; however, this may be changed by the user through manipulation of content source option selector 532-1 adjacent thereof. When options are minimal in number and are individually laid out, the default option may be highlighted. For example, “Content Type” setting 533 may indicate “Photo” option 533-1 as its default option among all the other options available, i.e., “Text” option 533-2, “Graphics” option 533-3, “Text/Photo” option 533-4, and like options. With the available options all laid out, users can change the highlighted option into another by direct selection. Any option changes on display area 530 are also detected by controller 120, highlighted on display area 530, and implicitly stored to memory 125 (block 430).

In another example, users can select another specific setting by selecting any other icon 514N-1 on resizable settings pane 510 corresponding to another specific setting. Upon doing so, options associated the selected icon/setting are generated on display area 530. With reference now in FIGS. 5F-5G, the user may select “Scale” setting icon 514C-1 on resizable settings pane 510, and as a result, options associated with the “Scale” setting are automatically generated on display area 530, i.e., “25%” option 534-1, “50%” option 534-2, “100%” option 534-3, and like options. In the same example, default option “100%” (534-3) for the “Scale” setting may be changed to “50%” (option 534-2) by the user (FIG. 5G) and controller 120 implicitly stores this change in memory 125 as the preferred option for “Scale” setting in executing the selected “Copy” function.

Settings pane 510, as it is being displayed on function landing screen display 110D, is further responsive to a leftward or rightward swiping gesture on user interface 105 for resizing. In FIG. 5G, for example, at any time while resizable settings pane 510 and display area 530 are simultaneously visible on function landing screen display 110D, thereby bifurcating user interface 105, resizable settings pane 510 can be swiped to a right of user interface 105 for expansion and thereby exposing content on the specific setting tabs 514N besides their respective icons 514N-1 as suggested by right arrow 512-7 (FIG. 5H) (block 435). When in its expanded state, resizable settings pane 510 shows each option selected from display area 530 on their respective text or option identifier placeholders 514N-3 and takes up again the display area of the user interface.

With reference back to FIG. 5E and 5G, “Text” option 533-2 and “50%” option 534-2 may be stored in memory 125 as the user-preferred options for “Content” setting 514A and “Scale” setting 514C, respectively. Now in FIG. 5H, users may swipe or drag a portion of settings pane 510 into right side 110-4 of user interface 105 for expansion and in its expanded state in FIG. 51, changes in the preferred options are reflected on respective text or option identifier placeholders 514A-3 and 514C-3. As such, when settings pane 510 is in its expanded state, a summary of the selected options is provided to the users prior to executing the function, much like to summary 316 on FIG. 3E.

Users may want to resume selection of preferred options on drawer 530. To return settings pane 510 to its reduced state and present display area 530, the users can either select a particular setting tab 514N thereon or drag a portion of the settings pane 510 to left side 110-3 of user interface 105, invoking closure (suggested by left arrow 512-8, FIG. 5I). Other alternative methods for expanding or reducing settings pane 530 may include the use of buttons or a combination of touch screen interaction methods known to skilled artisans. Options presented on display area 530 when resizable settings pane 510 is in its reduced state may be the same options that were displayed prior to its reduction. Similar to how drawer 330 for relatively large user interfaces optimizes the display area on user interface 105, the use of resizable settings pane 510 also prevents users from feeling lost while selecting settings and preferred options thereof.

Wherever the user may be on relatively small user interface 105, be it on function landing screen display 110C or 110D, a GUI element (e.g., execute button 348) may be provided for activating execution of the function based on the selected options reflected on respective text or option identifier placeholders 514N-3 on resizable settings pane 510. Said GUI element may be found on a portion of function landing screen display 110C or 110D, i.e., control bar 340 (FIG. 5A). Controller 120 may be configured to detect whether the said GUI element has been selected (FIG. 5J) and if so, retrieve the options stored in memory 125 and execute the function using the stored options (block 440). As each specific setting has a default or preconfigured option in imaging apparatus 100 that may either be retained or changed, the set of options used by controller 120 in executing the selected function may purely consist of either default options or user-selected options or may be combination of default and user-selected options.

### Additional Elements on Function Landing Screen Displays

Function landing screen displays 110B (FIGS. 3A-3E), 110C (FIG. 5A) and 110D (FIGS. 5B-5J) may further include a control bar (340) for indicating information related to the selected function as the user navigates thereon. Control bar 340 may be disposed adjacent top side 110-1 of function landing screen displays 110B, 110C, 110D for users to reference. As depicted in FIGS. 3A and 5A, control bar 340 may include identifier 342 which may be a text caption thereon identifying the function to be executed; a group of icons for executing one or more actions associated with the selected function, such as, for example, shortcut icon 344 for storing data on a currently generating display to memory 125; overflow icon 346 for executing one or more actions specific to the selected function (e.g., print sample copy, reset all, etc.); and/or aforementioned execute button 348 for activating execution of the selected function based on the selected or preferred options that are stored in memory 125. For relatively small user interfaces, identifier 342 may be operative to change based on the display (110) being generated. With reference to FIGS. 5A to 5C, identifier 342 may indicate the function being selected, which in these examples is the “Copy” function. In succeeding displays on FIGS. 5D-5E and 5F-5G, identifier 342 may indicate the setting being selected on settings pane 510, such are “Content” and “Scale” settings, respectively. Since settings pane 510 on its reduced state only includes icons that are associated with the settings thereon, identifier 342 serves as a guide for users to know what setting is the selected icon associated with. In addition, execute button 348 for relatively small user interfaces 105 may include text 348-1 to indicate the function being performed. Of course, other GUI elements, regardless for relatively large or smaller user interfaces, may be preconfigured to be placed on control bar 340 for indicating other information related to the selected function or to the imaging apparatus (100) to which the function is to be executed.

Imaging apparatus 100 may include one or more events thereon that may need the user's attention. An event can take the form of an update to an active process (i.e., a function being currently executed), errors or warnings directed to components or imaging supplies (e.g., toner, paper, etc.), and like activities on imaging apparatus 100. Controller 120 is typically configured to detect whether or not imaging apparatus 100 is having one or more events thereon. A notification may be determined by controller 120 to be appropriate for each event to be detected on imaging apparatus 100 such as, for example, an audio clip, a pop-up window citing information regarding the event, or a text message indicative of the event(s) on imaging apparatus 100, or a combination thereof.

With reference to FIG. 5K, each display 110 on user interface 105 may include a notifications bar (114A) for displaying information relating to imaging apparatus 100 itself or one or more events thereon. Notifications bar 114A may be disposed adjacent top 110-1 of the display for users to easily view. Information on notifications bar 114A may include a profile of imaging apparatus 100 (i.e., model or framework used, network location, system date and time, etc.) or of a user (i.e., badge identification, authenticated username, etc.) thereof. Each event on imaging apparatus 100 may be represented as an icon on notifications bar 114A and may be arranged in a particular manner such as, for example according to a degree of severity as predetermined by controller 120. Icons indicating active process (icon 114A-1), warnings (icon 114A-2) or errors (114A-3) on imaging apparatus 100 may be arranged from a leftmost portion of notifications bar 114A or adjacent left side 110-4 of user interface 105. An identifier (e.g., “Guest”) of the authenticated user of imaging apparatus 100 may also be provided as text 114A-4 on notification bar 114A. As depicted in FIG. 1, a center portion (114A-5) of notifications bar 114A may be used for displaying a roll-in message indicative of a latest event on imaging apparatus 100; the roll-in message may be moving from point A to point B on the notification bar. In other examples, notification bar 114A or a portion thereof may be operative to be generated in a particular color that corresponds to the severity of a new event (e.g., blue for active processes, yellow for warnings, red for errors, etc.). Other information relating to imaging apparatus 100 being used or to the function being executed thereon may also be added to notifications bar 114A.

In another example embodiment, notifications bar 114A is operative to be expanded to show more details associated with notifications. In FIGS. 3A and 5A, for example, gripper 114A-6 may be operative to be pulled downward by users from a portion of top side 110-1 of user interface 105 for expanding and thereby showing more details regarding the same notifications while selection of preferred options may be ongoing. Hook-and-dragging notifications bar 114A while icons and other information are displayed thereon thus creates a “peeking” effect such that, when notification bar 114A is in its expanded state, queue 115A of message notifications each corresponding to an icon shown thereon is presented on user interface 105, as depicted in FIG. 5K. For example, active process icon 114A-1, warning icon 114A-2, and error icon 114A-3 may each respectively correspond to active process-related message 115A-2, warning-related message 115A-3, and error-related message 115A-4.

Notifications on queue 115A may also include a status update of imaging apparatus 100 with regards to execution of a function thereon. In the same figure, message 115A-1 relates to imaging apparatus 100 being prepared or ready to execute any functions thereon. Each notification on queue 115A which relates to an event on imaging apparatus 100 may be a link operative to be selected by the user to show more details specific to the particular notification. For example, warning-related message 115A-3 may be selected by the user to determine more information relating to the warning Additionally, a button may be provided adjacent to a notification (i.e., “Cancel” button 115A-5) for removing the same notifications on queue 115A. It may also be noted that one or more notifications on queue 115A may be automatically removed by controller 120 thereon when it is determined that the one or more events causing the said notifications have been resolved. Date and time on imaging apparatus 100 as well as a network location thereof may also be displayed on notifications bar 114A in the form of, for example, text 114A-7 and 114A-8, respectively, as is apparent in the art. Buttons, links, or other GUI elements may also be provided on notifications bar 114A for users to proactively determine status of supplies on imaging apparatus (i.e., button 114A-9) or active process thereon (i.e., button 114A-10), regardless of a presence of a related message notification on queue 115A. How notification bar 114A may be oriented on user interface 105 and how information thereon may be arranged as well as how the GUI elements may be operative to perform on user interface 105 are hardwired onto memory 125 or controller 120 of imaging apparatus 100 upon manufacturing process.

Relative advantages of the many embodiments should now be apparent to skilled artisans. They include but are not limited to: (1) optimizing use of display spaces for relatively large and for smaller user interfaces; (2) simultaneous execution of panes and other elements using bifurcated displays thereby reducing the need to navigate through multiple displays, and (3) providing methods for users to simultaneously select options while viewing a real-time summary of the selected options prior to execution of the function.

The foregoing illustrates various aspects of the invention. It is not intended to be exhaustive. Rather, it is chosen to provide the best illustration of the principles of the invention and its practical application to enable one of ordinary skill in the art to utilize the invention. All modifications and variations are contemplated within the scope of the invention as determined by the appended claims. Relatively apparent modifications include combining one or more features of various embodiments with features of other embodiments.

1. A method of organizing display elements for optimizing display space on a user interface of an imaging apparatus, comprising:
generating a two-pane display on the user interface based on a user selection of a predetermined function to be performed by the imaging apparatus, the two-pane display including a first pane listing a plurality of settings associated with the predetermined function and a second pane adjacent to the first pane for displaying a preconfigured set of content associated with the predetermined function, each of the first and the second panes covering a portion of the user interface and being simultaneously visible to a user for independent manipulation and entry of user selections; and
determining whether one of the plurality of settings is selected on the first pane and upon a positive determination, launching over the second pane a transparent drawer including a plurality of options associated with said one of the plurality of settings, the drawer hovering only over the second pane such that the preconfigured set of content thereon and the user selections are substantially visible through the drawer, the plurality of options on the drawer for selection by the user and use in executing the predetermined function as the user navigates between each setting in the first pane and corresponding drawer.

2. The method of claim 1, further including identifying whether one or more options from the plurality of options on the drawer have been selected and upon a positive identification, storing the one or more options in a memory of the imaging apparatus for use in executing the predetermined function.

3. The method of claim 1, further including displaying, on the first pane, a setting identifier and one or more preconfigured set of options associated with each of the plurality of settings on the first pane.

4. The method of claim 3, further including replacing one or more preconfigured set of options associated with said one of the plurality of settings selected on the first pane with one or more options identified to be selected from the drawer.

5. The method of claim 1, further including identifying whether said one of the plurality of settings is deselected by the user on the first pane and upon a positive identification, automatically closing the drawer from being generated on the user interface thereby leaving the two-pane display displayed thereon.

6. The method of claim 1, further including detecting whether a swiping gesture has been made by the user from the transparent drawer to a side of the user interface and upon a positive detection, closing the transparent drawer from being generated on the user interface.

7. The method of claim 1, wherein the launching the transparent drawer further includes moving the transparent drawer in a sliding manner from a side adjacent the second pane on the user interface.

8. The method of claim 1, further including executing the predetermined function using, for each setting on the first pane, one of the preconfigured option associated with said each setting and the option selected by the user from the drawer.

9. An imaging apparatus, comprising:
a user interface having a bifurcated display simultaneously making visible to a user
a first pane having a plurality of settings associated with a predetermined function to be executed by the imaging apparatus;
a second pane adjacent to the first pane for displaying preset content and user selections; and
a transparent drawer adjacent the first pane and hovering only over the second pane such that the preset content on the second pane is and the user selections are substantially visible through the drawer, the drawer including a plurality of options associated with one of the plurality of settings from the first pane.

10. The imaging apparatus of claim 9, further including a controller for executing instructions to generate the bifurcated display on the user interface and a memory for storing a preconfigured set of options for each of the plurality of settings on the first pane and the preset content on the second pane.

11. The imaging apparatus of claim 10, wherein the controller further includes an instruction for determining whether one or more options from the plurality of options on the drawer have been selected by the user and upon a positive determination, using the one or more options in executing the predetermined function.

12. The imaging apparatus of claim 10, wherein the controller further includes an instruction for detecting one of a touch selection and a touch stroke performed by the user on the user interface while the bifurcated display is being generated thereon.

13. The imaging apparatus of claim 9, wherein an area of the drawer is defined within an area of the second pane such that the drawer is hovering within the second pane.

14. The imaging apparatus of claim 10, wherein the controller further includes an instruction for detecting whether one of the plurality of settings on the first pane has been selected by the user, and upon a positive detection, launching the transparent drawer on the user interface.

15. The imaging apparatus of claim 14, wherein the controller further includes an instruction for identifying whether said one of the plurality of settings detected to be selected by the user on the first pane has been deselected and upon a positive identification, closing the transparent drawer from being displayed on the user interface.

16. The imaging apparatus of claim 14, wherein said transparent drawer is operative to be closed in a swiping motion to a side of the user interface.

17. The imaging apparatus of claim 10, wherein each of the plurality of settings on the first pane is an independent tab including a setting identifier and one or more preconfigured options associated with said each setting, the one or more preconfigured options being operative to be replaced with one or more options determined by the controller to be selected by the user from a transparent drawer associated with said each of the plurality of settings.

18. The imaging apparatus of claim 9, wherein the first pane further includes a summary of options for the plurality of settings thereon, the summary of options including, for each setting on the first pane, one of a preconfigured option and a user-selected option from the drawer, the summary of options for use in executing the predetermined function.

19-20. (canceled)
